(19) United States
(12) Patent Application Publication
(10) Pub. No.: US 2013/0060908 A1
(43) Pub. Date: Mar. 7, 2013

(54) LOCATION-BASED STREAMING MEDIA CHANNELS

(71) Applicant: Wesley W. Whitmyer, JR., Stamford, CT (US)

(72) Inventor: Wesley W. Whitmyer, JR., Stamford, CT (US)

(21) Appl. No.: 13/324,816

(22) Filed: Dec. 13, 2011

Related U.S. Application Data
(60) Provisional application No. 61/531,929, filed on Sep. 7, 2011.

(51) Int. Cl. G06F 15/16

(52) U.S. Cl. 709/219

(57) ABSTRACT

A system for providing location-based streaming media to a user has a provider computer and at least one database accessible by the provider computer containing media content, the media content being associated with at least one location. A user hardware device is coupled to the provider computer over a network. The user hardware device communicates a location of the user hardware device to the provider computer. The provider computer to produces a list of media content corresponding to the location of the user hardware device and transmits the list to the user hardware device. The user hardware device communicates a media content selection to the provider computer and the provider computer streams the media content to the user hardware device based on the media content selection.

### CROSS-REFERENCE TO RELATED APPLICATIONS

The present application claims the benefit under 35 U.S.C. §119(e) of U.S. Provisional Patent Application Ser. No. 61,531,929 filed on Sep. 7, 2011, the content of which is incorporated herein by reference.

### FIELD OF THE INVENTION

The present invention relates generally to a media distribution system, and more specifically, relates to a media distribution system for streaming location-based media on a plurality of channels.

### BACKGROUND OF THE INVENTION

Traditional methods of distributing media include television, radio, and Internet web pages. Users turn to a particular channel or surf to a specific website and may be presented with media in any number of different formats. These traditional methods typically fall into two categories: broadcast and interactive media. In broadcast media, a user may turn to a particular television or radio channel and the media provider typically provides content with broad appeal to satisfy a variety of media content consumers. In interactive media, a user typically must actively search a website for specific media content.

U.S. Pat. No. 7,890,124 to Smith discloses a location-based information delivery system. Smith utilizes one or more variable geographic indicators to identify a geographic area. Once a geographic area has been identified, Smith's matching server is operative to transmit an informational message to subscriber devices located within the geographic area. The informational message may contain content relevant to the geographic area. A disadvantage of this system is that it does not allow streaming media, or permit users to select from among different types of subject matter content relevant to their detected location.

Broadcastr™ is a map based web service in which users select a nearby point of interest to hear a story about that location. Stories may also be selected by the storyteller. A disadvantage of this service is that does not stream media or permit user selection of content type or subject matter.

What is desired, therefore, is a system and method for providing users with location-based media of predetermined topics that is pertinent to the user's particular geo-location. What is further desired is a system and method that streams pertinent media content without requiring interaction from the user. Therefore, it would be beneficial to have a superior system and method for location-based streaming of media channels.

### SUMMARY OF THE INVENTION

The invention is directed to a location-based media distribution system. The media system receives a location from a content consumer, and displays a list of location-based content for the consumer to select and consume.

### PATENT APPLICATION DEFINITIONS

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “media data” as used herein means data which is widely accessible, whether over-the-air, or via cable, satellite, network, internetwork (including the Internet), distributed on storage media, or otherwise, without regard to the form or content thereof, and including but not limited to audio, video, text, images, animations, web pages and streaming media.

The terms “user” or “users” mean a person or persons, respectively, who access media data in any manner, whether alone or in one or more groups, whether in the same or various places, and whether at the same time or at various different times.

The term “network” as used herein includes both networks and internetworks of all kinds, including the Internet, and is not limited to any particular network or inter-network.

The term “presentation” as used herein means data in a form perceptible to a user, whether by sight, hearing, touch or otherwise, or any combination of these.

The terms “first” and “second” are used to distinguish one element, set, data, object or thing from another, and are not used to designate relative position or arrangement in time.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether constant, intermittent, or on an as needed basis and whether direct or through one or more other devices, apparatus, files, programs, media, components, networks, systems, subsystems, or means, and (b) a communications relationship, whether constant, intermittent, or on an as needed basis and whether direct, or through one or more other devices, apparatus, files, programs, media, components, networks, systems, subsystems, or means, and/or (c) a functional relationship whether constant, intermittent, or on an as needed basis and in which the operation of any one or more devices, apparatus, files, programs, media, components, networks, systems, subsystems, or means depends, in whole or in part, on the operation of any one or more others thereof.

The term “object” as used herein means a distinct software module or collection of computer code that possesses (1) data that uniquely separates the module or collection of computer code from other similar modules or collections, (2) attributes constituting a predetermined subset of data types describing media data usage and/or media data users and/or any other supporting data types or users, and (3) behavior which (i) limits access to such attributes by responding only to requests conforming to a predetermined published interface, and (ii) gathers data of such predetermined subset or merges objects which possess such data.

These and other objects of the present invention are achieved by provision of a system for providing location-based streaming media to a user having a provider computer and at least one database accessible by the provider computer containing media content, the media content being associated with at least one location. A user hardware device is coupled to the provider computer over a network. Software executes on the user hardware device to communicate a location of the user hardware device to the provider computer. Software executes on the provider computer to produce a list of media content corresponding to the location of the user hardware device, and to transmit the list to the user hardware device. Software executes on the user hardware device to communicate a media content selection to the provider computer. Software executes on the provider computer to stream the media content to the user hardware device based on the media content selection.

In some embodiments, there is a graphical user interface on the user hardware device. In some embodiments, software executes on the user hardware device to display the list of available media content. In some embodiments, software executes on the user hardware device to receive and present the selected media content to the user. In some embodiments, software executes on the provider computer to encode the selected media content prior to being streamed to the user hardware device. In some embodiments, the location of the user hardware device corresponds to the user's current location. In some embodiments, the location of the user hardware device is selected by the user. In some embodiments, the location of the user hardware device is automatically determined by the user hardware device. In some embodiments, the automatic determination is performed using GPS.

In some embodiments, the automatic determination is performed using wireless signals from a network connection of the user hardware device. In some embodiments, the location of the user hardware device includes an altitude. In some embodiments, software executes on the user hardware device for determining a further location the user is travelling to based on the user's direction and speed of travel. In some embodiments, the list of media content is updated as the user moves. In some embodiments, the user hardware device is embedded in a vehicle. In some embodiments, software executes on the user hardware device for the user to add or edit information relating to media content stored on the at least one database. In some embodiments, the user can rate the media content. In some embodiments, the list of media content is based in part on a user profile. In some embodiments, the user profile is managed by the user. In some embodiments, the media content is one of sports content, restaurant content, attractions content, weather content, positioning information, real estate content, radio station content, traffic content, and deals content.

In another embodiment of the present invention is a method for providing location-based streaming media to a user having the steps of receiving, by a provider computer from a user hardware device, a location of the user hardware device. A database accessible by the provider computer is searched for media content associated with the location. The provider computer sends to the user hardware device a list of media content associated with the location. The provider computer receives from the user hardware device a selection of media content from the list of media content. The provider computer then streams to the user hardware device the media content.

In some embodiments, the user hardware device the list of available media content. In some embodiments, the selected media content is encoded prior to being streamed to the user hardware device. In some embodiments, the location corresponds to the user's location. In some embodiments, the location is selected by the user. In some embodiments, the location is automatically determined by the user hardware device. In some embodiments, the automatic determination is performed using GPS. In some embodiments, the automatic determination is performed using wireless signals from a network connection of the user hardware device.

In some embodiments, the location includes an altitude. In some embodiments, a further location the user is travelling to is determined based on the user's direction and speed of travel. In some embodiments, the list of media content is updated as the user moves. In some embodiments, the user hardware device is embedded in a vehicle. In some embodiments, the user can add or edit information relating to media content stored on the at least one database. In some embodiments, the user rates the media content. In some embodiments, the media content is one of sports content, restaurant content, attractions content, weather content, positioning information, real estate content, radio station content, traffic content, and deals content.

In another embodiment of the present invention is a system for providing location-based streaming media to a user having a provider computer and at least one database accessible by the provider computer containing media content, the media content being associated with at least one location. A user hardware device is coupled to the provider computer over a network. Software executes on the user hardware device to communicate a location of the user hardware device to the provider computer, the location automatically determined by the user hardware device. Software executes on the provider computer to produce a list of media content corresponding to the location of the user hardware device, and to transmit the list to said user hardware device. Software executes on the user hardware device for displaying the list of media content to the user. Software executes on the user hardware device to communicate a media content selection to the provider computer. Software executes on the provider computer to retrieve the media content from the at least one database. Software executes on the provider computer to encode and stream the media content to the user hardware device based on the media content selection. Software executes on the user hardware device for displaying the selected media content.

In some embodiments, the automatic determination is performed using GPS. In some embodiments, the automatic determination is performed using wireless signals from a network connection of the user hardware device. In some embodiments, the list of media content is updated as the user moves. In some embodiments, the user hardware device is embedded in a vehicle.

### BRIEF DESCRIPTION OF THE DRAWINGS

FIG. 1 is a schematic diagram of a system for location-based media streaming.

FIG. 2 is a block diagram depicting operations of the location-based media streaming system of FIG. 1.

### DETAILED DESCRIPTION OF THE INVENTION

The exemplary embodiments of the present invention may be further understood with reference to the following description and the related appended drawings, wherein like elements are provided with the same reference numerals. The following description is presented for illustrative purposes only and the present teachings should not be limited to these aspects. Any computer configuration and architecture satisfying the speed and interface requirements herein described may be suitable for implementing the system and method of the present invention.

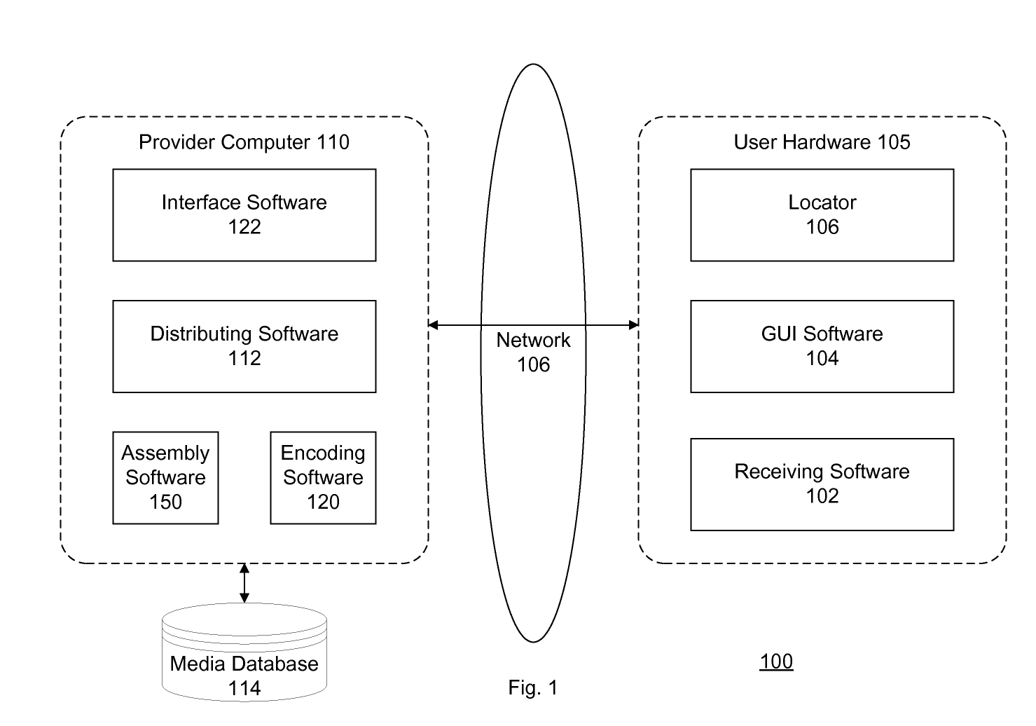

As best seen in FIG. 1, a schematic diagram depicting a location-based media streaming system 100 is shown. Location-based media streaming system 100 has Provider Computer (or computers) 110, which may be in electronic communication with a Media Database 114. Media Database 114 may contain media of any type, including text, pictures, video, sound, etc. The media content may be interactive, allowing the user to engage with the content provided. For example, the media content may be a map of points of interest, allowing the user to select a point of interest to find out more information. The media content may also be passive, only allowing the user to watch or listen to the content.

Provider Computer 110 has assembly software 150, which may be used to assemble media into streams. A plurality of content, including the same or different types of media, may be assembled together into a continuous stream of content. For example, assembly software 150 may assemble several audio and video files into a single stream. Provider Computer 110 may also have encoding software 120 to encode the media into a format capable of being played on a User Hardware Device 105.

Provider Computer 110 has distributing software 112 which may provide the media to User Hardware Device 105 over a Network 108, such as the Internet. User hardware device 105 has receiving software 102 which may provide the ability for a user to access (e.g., hear, view, read, etc.) the distributed media. User Hardware Device 105 may comprise any type of computing device, or may even comprise multiple devices in electronic communication with each other. Optionally, User Hardware Device 105 is a mobile device, but it may also comprise a PC, laptop, mobile phone, tablet, automobile dashboard computer, or any number of other potential devices.

Media Database 114 may contain sound clips, video clips, pictures and text or any other media format and may also contain brochures, coupons, music, speeches, lectures, narrations, news/weather, oral stories, presentations, movies, performances, or any other content. Distributing software 112 may distribute media over Network 108 (e.g., wired, wireless, etc.) to receiving software 102 for access by a user. In this way, a user of User Hardware Device 105 (e.g., PC, tablet, mobile device, smart phone, laptop, etc.) is able to consume (e.g., hear, watch, read, etc.) the distributed media.

Access to the media stored in Media Database 114 may be controlled in any number of ways. For example, it may be freely broadcasted along predetermined communication mediums (e.g., radio waves, web feeds, etc.). It may also be distributed to users who subscribe (e.g., on a website, etc.) to receive particular media content, although not limited thereto. Users may subscribe to the media distribution by paying a one-time or subscription fee. Additionally, a fee may not be required, and the location-based media streaming system 100 may be supported by advertisements.

Users may provide Provider Computer 110 with information about themselves, including demographic information, preferences, etc. This may help the system to determine appropriate content that is targeted to each specific user. Users may provide a profile of their information that may be stored locally on Provider Computer 110, or in a database attached to Provider Computer 110. The profile may also be stored remotely on User Hardware Device 105 and transmitted to Provider Computer 110 upon each connection of User Hardware Device 105 to Provider Computer 110. It is to be appreciated that any information utilized by the system in performance of the present teachings may be stored and shared anywhere along Network 108.

While it is to be appreciated that media content may be provided to the system (e.g., stored in the database, etc.) with location-based identifying information, encoding software 120 may be utilized to add (e.g., associate, etc.) location-based information to media content. For example, encoding software 120 may parse text for references to geographic locations, although not limited thereto. When the software determines that there is a reference to a geographical location, it may then associate that media content with the geographical location in Media Database 114. Similarly, one skilled in the art would appreciated that encoding software 120 may utilize technologies to interpret images, video or sound to determine references to locations and then associate those locations to media having such references in Media Database 114. Content may be associated with one or more locations by being “tagged” with a location, which may be done by a content provider when the content is added to Media Database 114, or alternatively may be done by users of location-based media streaming system 100, although not limited thereto.

User Hardware Device 105 may comprise a locator 106. Locator 106 may provide (or assist in determining) the geo-location of User Hardware Device 105. One skilled in the art would appreciate that the present teachings could utilize any number of different technologies to determine the location of the user and/or User Hardware Device 105 and the present teachings are not limited to any particular arrangement disclosed herein. For example, User Hardware Device 105 may optionally incorporate a global positioning system (GPS) receiver as a locator 106. Optionally, locator 106 may help the system determine location by using cellular towers, wireless networks, or radio-navigation systems such as long range navigation (LORAN), although not limited thereto.

With the position of User Hardware Device 105 or of the user, the system may provide location-based media content to the user (e.g., may use receiving software 102, etc.). If User Hardware Device 105 (or the user) is traveling, locator 106 may help to determine the direction, velocity, and altitude, although not limited thereto, in order to anticipate appropriate location-based media to distribute to the user. For example, location-based media streaming system 100 may provide content for upcoming destinations along a pre-determined route (e.g., using a GPS device supplying travel directions, etc.) or for a final destination. Location-based media streaming system 100 may also provide two options for location-based media content such as content for the user's current location and content for the destination of the user.

Provider Computer 110 may comprise a plurality of computers that are networked together. If one of the computers is not capable of handling the request from User Hardware Device 105, the request may be forwarded to a second computer to respond to User Hardware Device 105. Additionally, there may be a plurality of Media Databases 114. For example, all of the media content may be stored on a single database, with a plurality of backup databases. If the first database is busy, the streaming media may be streamed from one of the backup databases. Alternatively, different databases may store different types of media content. For example, one database may store all video content while a second database may store all audio content etc.

It is to be appreciated that User Hardware Device 105 may be provided to execute software 104, 120, 150 stored on computer readable media or to store information on Media Database 114, and the present teachings are not limited to any particular configuration disclosed herein. In addition, Provider Computer 110 may communicate with Media Database 114 over Network 108, such as the Internet, and the present teachings are similarly not limited to any network configuration disclosed herein. Still further, each Provider Computer 110 or computers may comprise any number of processors.

User Hardware Device 105 may comprise a Graphical User Interface or GUI software 104 (e.g., display software, etc.) executing on a computer readable medium for providing an interface to a user of the system. Optionally, GUI software 104 may provide a simple, topic-based interface (not shown). This way, the user can select a channel by topic and then stream location-appropriate media without the need for any further interaction with the system (e.g., to search for appropriate content, etc.). Optionally, the user may select the “restaurant channel” and be provided with streaming media pertinent to the user's geographic proximity. Since the system may also determine the user's velocity, direction, altitude (e.g., helpful in multi-floored buildings), etc., the system may stream media content such as restaurant reviews for upcoming restaurants (e.g., in the direction the user is traveling). In this way, the content may change as the user's location changes.

As a result, it is to be appreciated that the media stored in Media Database 114 may be “tagged” (e.g., associated) with a topic or topics as well as with a location or locations, although not limited thereto. Media content may have multiple tags in any number of situations. For example, a restaurant may have multiple locations or a particular work of media content may reference multiple geographic locations. In addition, a particular work of media content may have multiple topics. For example, media content concerning a sports arena may be applicable to both a sports channel as well as to an attractions channel, although not limited thereto.

Optionally, the system may provide a “deals” channel which may provide streaming media content of offers that relate to nearby businesses. For example, if a user of a system is traveling, the deals channel may provide offers for upcoming restaurants or stores in the user's direction of travel. The system may also provide an interface for loading media content, including deals, into Media Database 114. This way, any number of people (e.g., marketers, business owners, etc.) can upload location-based deals (or other media) into the system for automatic distribution to users. Interface software 122 may comprise a web page, although not limited thereto, providing centralized access for users to interface with the system.

Similarly, interface software 122 may provide the ability for “interface users” to review media content. Interface users may be able to tag the media with locations and topics, as well as rate media. Using a ratings scheme, optionally, the highest rated media content would be distributed with priority over lower-rated content. In addition, interface users may provide other categorizations to media content, which may relate media content to users in other ways, such as by using information provided by the user in a profile. In this way, the system may comprise a social networking component, whereby “friends” who are part of the user's social network may be given priority and the ability to interact with each other and the content. Further, media content which is “liked” by friends may be given priority in distribution to particular users.

Optionally, interface users may create their own personalized channels which may comprise, for example, other “standard” channels. This way, user A (not shown) can create a channel comprising sports, weather and traffic. When user A is tuned to his/her channel he/she will receive location-based media comprising sports, weather and traffic. It is to be appreciated that these examples are not intended to limit the present teachings.

GUI software 104 may provide a simple interface (not shown) that does not require significant interaction by the user. Instead, the user may simply select a channel and be provided location-based media content for that channel as the user travels. Sports content may include scores, schedules, news, statistics, etc. for nearby sports teams. Restaurant content may include menus, specials, hours, etc. for nearby restaurants. Attractions content may include facility information, hours, ticket prices, etc. for nearby attractions. Weather content may include reports, etc. for the location of the user. Current location content may include positioning information, etc., for the location of the user. Real estate content may include open houses, recent sales, for sale information, neighborhood information, etc. for the location of the user. Radio station content may include music lists, schedules, etc. for nearby radio stations. Traffic content may include maps, news, etc. for the location of the user. Deals content may include offers, coupons, advertisements, etc. for nearby businesses. Any number of channels may be utilized with the present teachings, as one skilled in the art would appreciate, and the present teachings are not limited to any particular arrangement disclosed herein.

Optionally, GUI software 104 may comprise an alert (e.g., beep, flashing light, etc., not shown) in order to alert a user when new media content is available. It is appreciated that optionally, the user may wish to pause the receipt of distributed media and an alert may alert the user to resume streaming media or otherwise draw attention to available content.

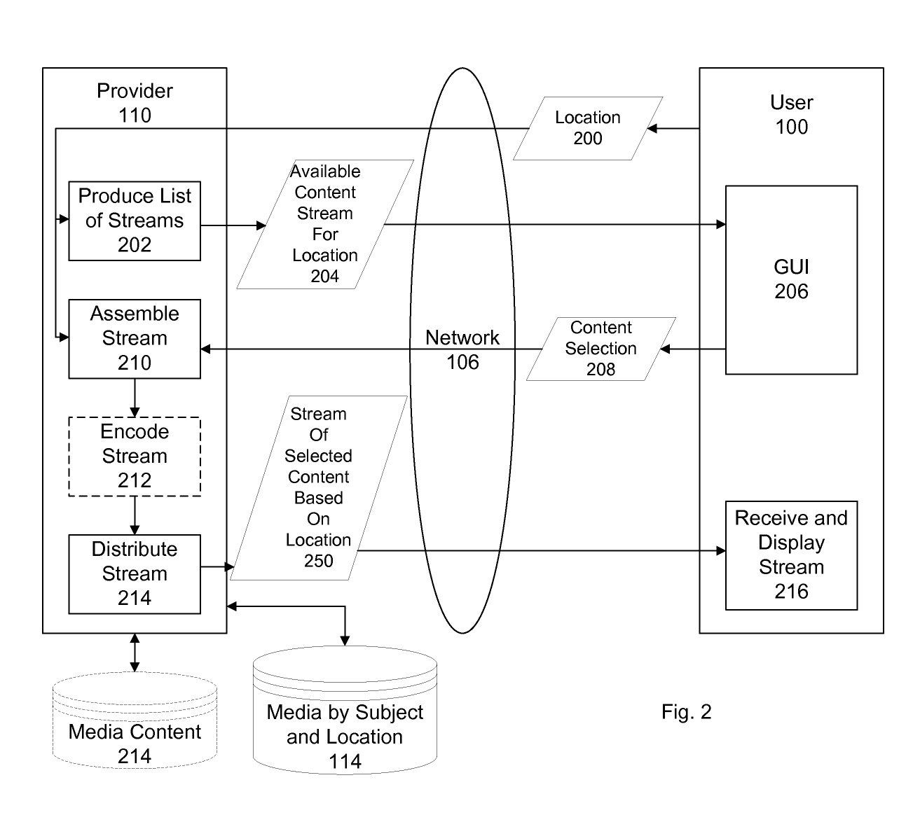

As best seen in FIG. 2, a block diagram illustrating various operations according to location-based media streaming system 100 which may be implemented using features described with respect to FIG. 1, is shown. A User Hardware Device 105 transmits a location 200 over Network 108 to a Provider Computer 110. The location maybe automatically transmitted every time the user powers on User Hardware Device 105 or the user may initiate a software application which transmits a location 200 to Provider Computer 110. Location 200 may be the location of the user as determined by GPS or another suitable means further described with respect to FIG. 1. Provider Computer 110 produces a list of streams 202 based upon location 200, and the media available in Media Database 114 or optionally, in Media Content Database 214, and transmits the list of available content streams 204 to User Hardware Device 105 over Network 108. User Hardware Device 105 receives the list of available content streams 204 and displays the available content stream for location 204 to the user via GUI 206 or another suitable means. The user can then select a desired content stream, and transmit the content selection 208 to Provider Computer 110 over Network 108. Provider Computer 110 receives content selection 208 and assembles a stream 210 of selected content 250 from Media Database 114 or 214 based upon location 200, and content selection 208. Optionally, stream 250 is encoded 212 to a file format that is playable by User Hardware Device 105. Stream 250 is then distributed 214 over Network 108 to User Hardware Device 105, where it is received and presented 216 to the user.

While the present teachings have been described above in terms of specific examples, it is to be understood that they are not limited to these disclosed examples. Many modifications will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A system for providing location-based streaming media to a user comprising:
a provider computer;
at least one database accessible by said provider computer containing media content, said media content being associated with at least one location;
a user hardware device coupled to said provider computer over a network;
software executing on said user hardware device to communicate a location of said user hardware device to said provider computer;
software executing on said provider computer to produce a list of media content corresponding to said location of said user hardware device, and to transmit said list to said user hardware device;
software executing on said user hardware device to communicate a media content selection to said provider computer; and
software executing on said provider computer to stream said media content to said user hardware device based on said media content selection.

2. The system of claim 1, further comprising a graphical user interface on said user hardware device.

3. The system of claim 1, further comprising software executing on said user hardware device to display said list of available media content.

4. The system of claim 1, further comprising software executing on said user hardware device to receive and present said selected media content to the user.

5. The system of claim 1, further comprising software executing on said provider computer for encoding said selected media content prior to being streamed to said user hardware device.

6. The system of claim 1, wherein said location of said user hardware device corresponds to the user's current location.

7. The system of claim 6, wherein said location of said user hardware device is selected by the user.

8. The system of claim 6, wherein said location of said user hardware device is automatically determined by said user hardware device.

9. The system of claim 8, wherein said automatic determination is performed using GPS.

10. The system of claim 8, wherein said automatic determination is performed using wireless signals from a network connection of said user hardware device.

11. The system of claim 6, wherein said location of said user hardware device includes an altitude.

12. The system of claim 6, further comprising software executing on said user hardware device for determining a further location the user is travelling to based on the user's direction and speed of travel.

14. The system of claim 1, wherein said list of media content is updated as the user moves.

15. The system of claim 1, wherein said user hardware device is embedded in a vehicle.

16. The system of claim 1, further comprising software executing on said user hardware device for the user to add or edit information relating to media content stored on said at least one database.

17. The system of claim 16, wherein the user can rate said media content.

18. The system of claim 1, wherein said list of media content is based in part on a user profile.

19. The system of claim 18, wherein said user profile is managed by the user.

20. The system of claim 1, wherein said media content is one of sports content, restaurant content, attractions content, weather content, positioning information, real estate content, radio station content, traffic content, and deals content.

21. A method for providing location-based streaming media to a user comprising the steps of:
receiving, by a provider computer from a user hardware device, a location of the user hardware device,
searching a database accessible by the provider computer for media content associated with the location;
sending, from the provider computer to the user hardware device, a list of media content associated with the location;
receiving, by the provider computer from the user hardware device, a selection of media content from the list of media content; and
streaming, from the provider computer to the user hardware device, the media content.

22. The method of claim 21, further comprising the step of displaying on the user hardware device the list of available media content.

23. The method of claim 21, further comprising the step of encoding the selected media content prior to being streamed to the user hardware device.

24. The method of claim 21, wherein the location corresponds to the user's location.

25. The method of claim 21, wherein the location is selected by the user.

26. The method of claim 24, wherein the location is automatically determined by the user hardware device.

27. The method of claim 26, wherein the automatic determination is performed using GPS.

28. The method of claim 24, wherein the automatic determination is performed using wireless signals from a network connection of the user hardware device.

29. The method of claim 24, wherein the location includes an altitude.

30. The method of claim 24, further comprising the step of determining a further location the user is travelling to based on the user's direction and speed of travel.

31. The method of claim 21, wherein the list of media content is updated as the user moves.

32. The method of claim 21, wherein the user hardware device is embedded in a vehicle.

33. The method of claim 21, further comprising the step of adding or editing, by the user, information relating to media content stored on the at least one database.

34. The method of claim 21, further comprising the step of rating the media content by the user.

35. The method of claim 21, wherein the media content is one of sports content, restaurant content, attractions content, weather content, positioning information, real estate content, radio station content, traffic content, and deals content.

36. A system for providing location-based streaming media comprising:
a provider computer connected to a network;
at least one database accessible by said provider computer containing media content, said media content being associated with at least one location;
software executing on said provider computer to receive a location over said network;
software executing on said provider computer to produce a list of media content corresponding to said location and to transmit said list over said network;
software executing on said provider computer to receive a media content selection over said network;
software executing on said provider computer to retrieve said media content from said at least one database; and
software executing on said provider computer to stream said media content over said network based on said media content selection.

37. The system of claim 36, further comprising software executing on said provider computer for encoding said selected media content prior to being streamed over said network.

38. The system of claim 36, further comprising a user hardware device that automatically determines said location and transmits said location to said provider computer over said network.

39. The system of claim 38, wherein said automatic determination is performed using GPS.

40. The system of claim 38, wherein said automatic determination is performed using wireless signals from a network connection of said user hardware device.

41. The system of claim 38, wherein said location of said user hardware device includes an altitude.

42. The system of claim 38, further comprising software executing on said user hardware device for determining a further location said user hardware device is travelling to based on said user hardware devices' direction and speed of travel.

43. The system of claim 38, wherein said list of media content is updated as said user hardware device moves.

44. The system of claim 36, wherein said media content is one of sports content, restaurant content, attractions content, weather content, positioning information, real estate content, radio station content, traffic content, and deals content.
